(19) United States
(12) Patent Application Publication
(10) Pub. No.: US 2007/0042792 A1
(43) Pub. Date: Feb. 22, 2007

(54) Determining message format according to status information

(76) Inventors: Josh Perfetto, San Jose, CA (US); Saurav Chatterjee, San Jose, CA (US); Steven D. Schramm, San Jose, CA (US); Mike White, San Jose, CA (US)

Correspondence Address: COURTNEY STANIFORD & GREGORY LLP, P.O. BOX 9686, SAN JOSE, CA, 95157, US

(21) Appl. No.: 11/509,494

(22) Filed: Aug. 23, 2006

Related U.S. Application Data
(63) Continuation-in-part of application No. 10/890,922, filed on Jul. 14, 2004.
(60) Provisional application No. 60/487,143, filed on Jul. 14, 2003.
(60) Provisional application No. 60/710,998, filed on Aug. 23, 2005.
(60) Provisional application No. 60/711,051, filed on Aug. 23, 2005.
(60) Provisional application No. 60/711,053, filed on Aug. 23, 2005.

(51) Int. Cl. H04M 1/00; H04Q 7/20; H04M 3/00

(52) U.S. Cl. 455/461; 379/355.04

(57) ABSTRACT

Automatic determination of message format according to status information is described. The formatting includes selecting via a calling device a recipient to receive a communication. A communication request is generated corresponding to the communication. A status of the recipient is automatically determined. The status includes information of a service that supports the communication request. The communication request is formatted to have a format that corresponds to the status, and the formatted communication request is transferred to a target device of the recipient via a data coupling that supports the format.

### RELATED APPLICATIONS

This application is a continuation-in-part (CIP) application of U.S. patent application Ser. No. 10/890,922, filed Jul. 14, 2004, which claims the benefit of U.S. patent application No. 60/487,143, filed Jul. 14, 2003.

This application claims the benefit of U.S. patent application Ser. No. 60/710,998, filed Aug. 23, 2005.

This application claims the benefit of U.S. patent application Ser. No. 60/711,051, filed Aug. 23, 2005.

This application claims the benefit of U.S. patent application Ser. No. 60/711,053, filed Aug. 23, 2005.

### TECHNICAL FIELD

The disclosure herein relates generally to communication systems and, in particular, to wireless communication systems.

### BACKGROUND

Mobile communications in today's real-time enterprise can be challenging. The problem is further complicated by changes in the workplace which have led to a more geographically dispersed and highly mobile workforce. In spite of the popularity of electronic mail (email), large numbers of people and employees still depend upon numerous other types of communications to collaborate with colleagues and drive business success. This is especially true for those in sales, service, operations and management roles who rely upon timely access to and coordination with colleagues as well as other employees, customers, partners and suppliers. Thus, communications remain an essential means of conducting business and staying in contact.

As a result of communications being so critical to business today, many professionals and enterprise employees now handle very large numbers of communications each business day. These communications can include disparate types of communications like emails, voicemails, instant messaging to name a few. Managing these large numbers and disparate types of communications consumes large amounts of time during the typical business day. For the growing number of people who spend a significant part of their day away from their offices or in meetings or other events, managing this large number of communications is highly time-consuming, frustrating and inefficient. Consequently, there is a need for communication systems that provide efficient, timely, and proactive real-time management of multiple types of communications.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram of an active mobile collaboration (AMC) system, under an embodiment.

FIG. 2 is a block diagram of a communications system that includes an AMC system, under an alternative embodiment.

FIG. 3 is a block diagram of a communications system that includes an AMC system, under another alternative embodiment.

FIG. 4 is a flow diagram for determining message format according to status information, under an embodiment.

FIG. 5 is a template of the Notification of Missed Call from Non-Subscriber alert message (NO-1a), under an embodiment.

FIG. 6 is a template of the Response to Missed Call from Non-Subscriber alert message (NO-1b), under an embodiment.

FIG. 7 is a template of the Active Call Request to a Non-Subscriber (ON-1a), under an embodiment.

FIG. 8 is a block diagram of an AMC system, under an alternative embodiment.

FIG. 9 is a block diagram of an AMC system, under another alternative embodiment.

FIG. 10 is a block diagram of an AMC system, under yet another alternative embodiment.

FIG. 11 is a block diagram of an AMC system in an enterprise domain, under another alternative embodiment.

FIG. 12 is a block diagram of an AMC system in a public domain coupled across components of an enterprise domain, under another alternative embodiment.

FIG. 13 is a block diagram of an AMC system in an enterprise domain, under still another alternative embodiment.

FIG. 14 is a block diagram of an active mobile collaboration (AMC) system, under an embodiment.

### DETAILED DESCRIPTION

Automatic determination of message format according to status information is described. The formatting includes selecting via a calling device a recipient to receive a communication. A communication request is generated corresponding to the communication. A status of the recipient is automatically determined. The status includes information of a service that supports the communication request. The communication request is formatted to have a format that corresponds to the status, and the formatted communication request is transferred to a target device of the recipient via a data coupling that supports the format.

The AMC system of an embodiment automatically determines a correct addressing or formatting scheme for a message recipient based on attributes of the recipient. The attributes include whether the selected message recipient is a subscriber or non-subscriber of services of the AMC system. While contact information of the selected recipient is in a directory to which the caller has access, the subscriber status information of the recipient may not be available. When the recipient is a subscriber of the AMC system, the generated message is transferred to the recipient via components of the AMC system. When the recipient is not a subscriber of the AMC system, components of the AMC system determines a format for transferring the message to the recipient. Example formats for messaging a non-subscriber include an electronic mail message format, an instant message format, a Short Message Service (SMS) format, a Multimedia Messaging Service (MMS) format, an Enhanced Messaging Service (EMS) format, and a voice mail format to name a few. Thus, the AMC system determines the appropriate method to use in delivering messages to anyone in a contact list regardless of attributes or membership in AMC system. This allows a user to select a recipient from a contact list without know whether the recipient is inside or outside of the AMC system. The AMC system automatically determines how to construct and deliver the message so that, without any required user input, a secure AMC system message is transferred when the recipient is inside the AMC system, and another delivery mechanism is used as appropriate when the recipient is outside the AMC system.

In the following description, numerous specific details are introduced to provide a thorough understanding of, and enabling description for, embodiments of the communications systems. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

A communication system is provided herein that uses client-server architectures to improve the efficiency of multiple types of communications. The communication system, referred to herein as the active mobile collaboration (AMC) system, includes a facilitator. The facilitator of an embodiment is an application hosted on one or more servers or other processor-based devices, and communicates a portable or mobile communications device via one or more couplings. The facilitator communicates with the AMC client of a host portable device via a network coupling for example. The facilitator of alternative embodiments can be distributed among one or more portable processor-based devices including the same communication devices as the client application.

The AMC system also includes a client. The client, also referred to as the AMC client, is a component application of a variety of processor-based mobile communication devices and telephones. The components of the AMC system function to improve efficiency of communications by allowing communication device users to increase accessibility of enterprise and personal contact information from mobile phones and other personal digital assistants (PDAs), dynamically manage how and when mobile communications take place, intelligently screen messages, regardless of message type, based on identity of a messaging party, urgency, and subject matter, and determine which contacts in a directory are available to talk and which ones choose not to be disturbed, to name a few.

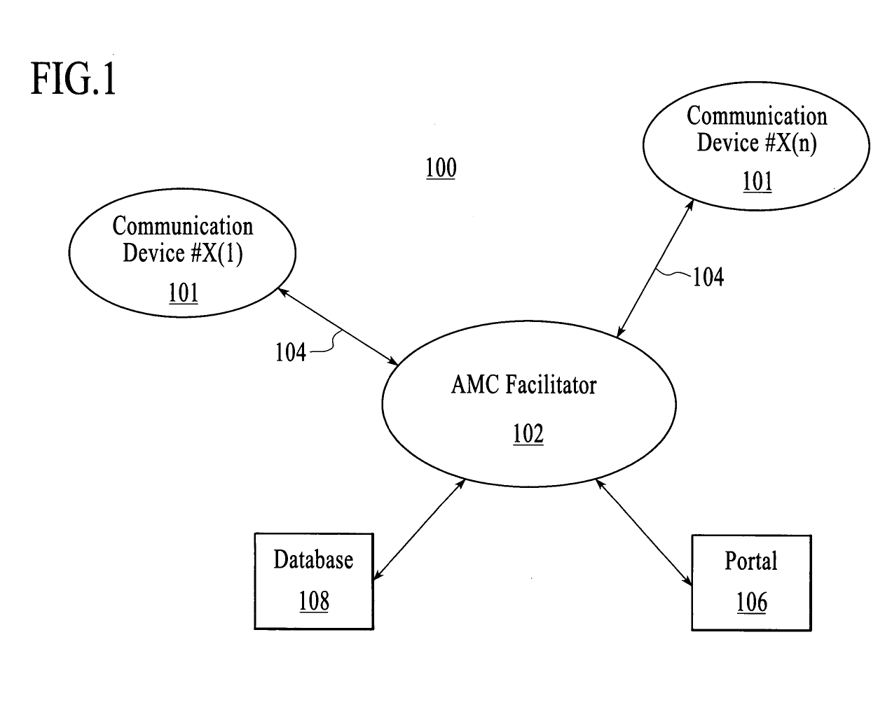

FIG. 1 is a block diagram of an active mobile collaboration (AMC) system 100, under an embodiment. The AMC system 100 includes any number X(n) of communication devices 101 coupled for communication via one or more facilitators 102 and one or more couplings 104. One or more of the communication devices 101 include an AMC client application. Likewise, the facilitator 102, also referred to herein as the AMC server 102, includes a facilitator application. The AMC client and facilitator function to allow users of the communication devices to dynamically manage how and when mobile calls take place, intelligently screen calls based on caller identity, urgency, and subject matter, determine which contacts in a directory are available to talk and which ones choose not to be disturbed, and increase accessibility of enterprise and personal contact information from mobile phones. The AMC system 100 of an embodiment also includes couplings with one or more portals 106 and/or one or more databases 108, but is not so limited.

The communication devices 101 and facilitators 102 described herein are processor-based components running or hosting numerous applications or programs. As such, the communication devices 101 and facilitators 102 can include one or more processors (not shown) coupled among any number/combination of components (not shown) known in the art, for example buses, controllers, memory devices, and data input/output (I/0) devices, in any number of combinations.

The communication devices 101 described herein include processor-based electronic devices, for example, cellular telephones, personal computers, portable computing devices, portable telephones, portable communication devices, subscriber devices or units, PDAs, devices, wireless devices, wireline devices, voice over Internet Protocol (VOIP) devices, private branch exchange (PBX) devices, clients, soft clients, and desktop clients to name a few. The communication devices 101, also referred to as handsets, client devices, devices, mobile communication devices, and portable communication devices, can include all such devices and equivalents, and are not limited to the communication devices described above.

The couplings 104 include wired couplings, wireless couplings, and hybrid wired/wireless couplings, but are not so limited. Furthermore, the couplings 104 can include various networks and/or network components (not shown) of a communication service provider or carrier, but are not so limited. The network and corresponding network components, when present in the couplings 104, can be any of a number of network types known in the art including, but not limited to, local area networks (LANs), metropolitan area networks (MANs), wide area networks (WANs), proprietary networks, backend networks, and the Internet.

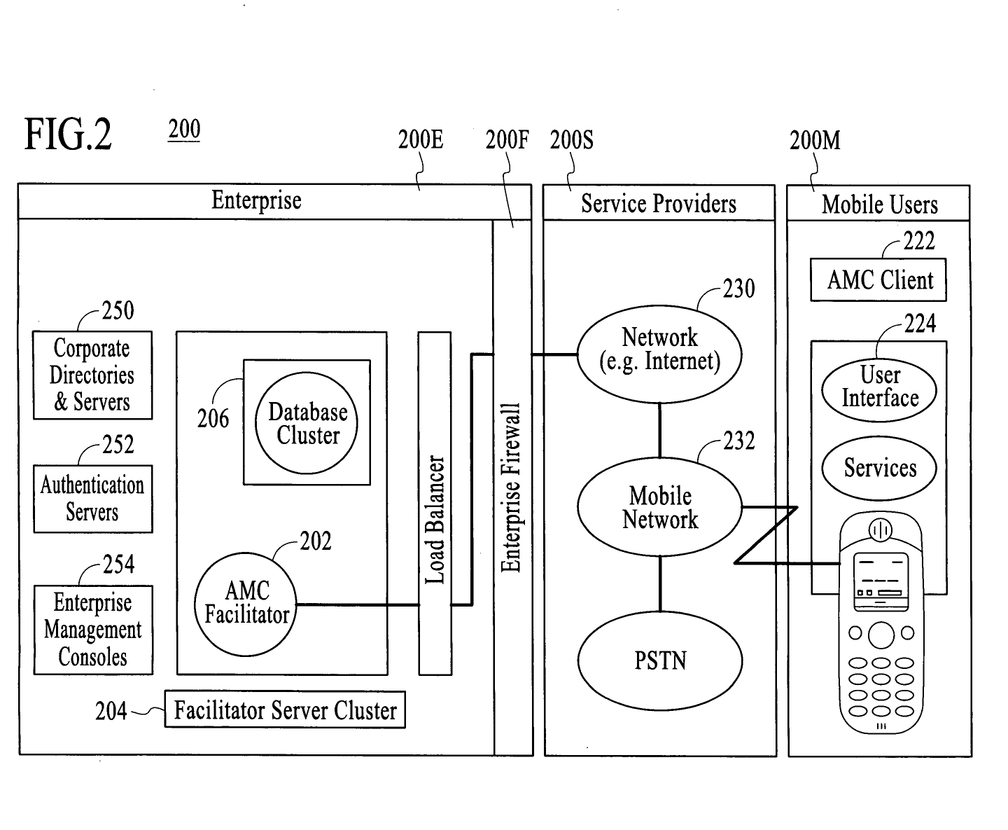

FIG. 2 is a block diagram of a communications system 200 that includes an AMC system, under an alternative embodiment. The AMC system includes a facilitator 202 and a client 222 as described elsewhere herein. The facilitator 202 can be one or more facilitators that form a facilitator server cluster 204 and/or database cluster 206 within the enterprise 200E that are resident behind the enterprise firewall 200F, but the AMC system is not so limited. The host enterprise 200E also includes numerous other components, for example, corporate directories and servers 250, authentication servers 252, and enterprise management consoles 254 to name a few. The facilitator 202 is an integrated component of the host enterprise 200E and as such integrates with one or more components of the enterprise 200E. For example, couplings between the facilitator 202 and messaging and collaboration servers (e.g. Microsoft® Exchange) and/or corporate or other directories of the enterprise 200E allow easy, over-the-air download of personal and corporate contact information to devices, as well as searching of personal and corporate contact directories from the device. Other information of the enterprise 200E can also be delivered to the devices using the AMC system, information including but not limited to calendar information, calendar alerts, calendar reminders, etc.

The facilitator 202 couples to a device of one or more users via one or more network couplings. As an example, the facilitator 202 couples to devices using one or more service provider networks 200S. In this example, the facilitator 202 couples to one or more service provider networks or infrastructures 200S via network couplings 230 (e.g. Internet), and then couples to devices 200M via the respective service provider networks 232. The AMC system protects data transfers between the facilitators 202 and the devices 200M using secure couplings, for example, protected with end-to-end security protocols like Secure Sockets Layer (SSL) or Transport Layer Security TLS cryptographic protocols.

The devices 200M of an embodiment include the AMC client 222. The AMC client 222, also referred to as the client 222, includes a graphical user interface 224 that integrates with the device applications and allows users to receive and scan enterprise information of the enterprise 200E. The enterprise information includes contact information, directory information, alerts that can include calendar reminders, conference notifications and call requests from colleagues, as described herein and in the Related Applications. Call requests include relevant details such as name, urgency, and subject matter to help users move business forward while screening out unwanted interruptions. The client 222 further provides a presence-aware phonebook that lets users find a contact and determine if the contact is available to talk, even before placing a call. The client 222 eliminates the need to manually enter contacts into the host device 200M. Instead, users download personal and/or corporate contact information over-the-air to their devices. The facilitator 202 and client 222 of the AMC system therefore provide automated, two-way synchronization to ensure contacts are backed up and up to date at the enterprise 200E.

An example of the AMC system of an embodiment is available as the Orative Enterprise Software from Orative Corporation of San Jose, California. The facilitator is available as the Orative Enterprise Server (e.g. runs on a standards-based, Java 2, Enterprise Edition (J2EE) platform that operates securely behind the enterprise firewall). The client is available as the Orative Client Software (e.g. runs on a variety of popular devices, and leverages the latest application development environments including Symbian OS, Java and BREW to name a few).

While dynamically managing how and when mobile calls take place and intelligently screening calls based on numerous factors described above, the components of the AMC system also improve efficiency of voice communications by increasing accessibility of enterprise and personal contact information from mobile phones. Components of the AMC system of an embodiment support aggregation and management of contact information from various sources including, but not limited to, directories resident on desktop computers, corporate/enterprise directories, and contact information of the device native phonebook, and provide data coupling between those sources and devices hosting the AMC client. This contact information is managed by providing the user with access via the device to dynamically integrated contacts of a contact list and a number of phonebooks from multiple sources. The dynamic integration of multiple disparate directories provided by the AMC system of an embodiment allows a user to indicate the contacts he/she desires among all directories of a corresponding enterprise server, and then dynamically synchronizes all enterprise directories so as to place the desired information from the directories together into a common AMC phonebook, as described in detail below.

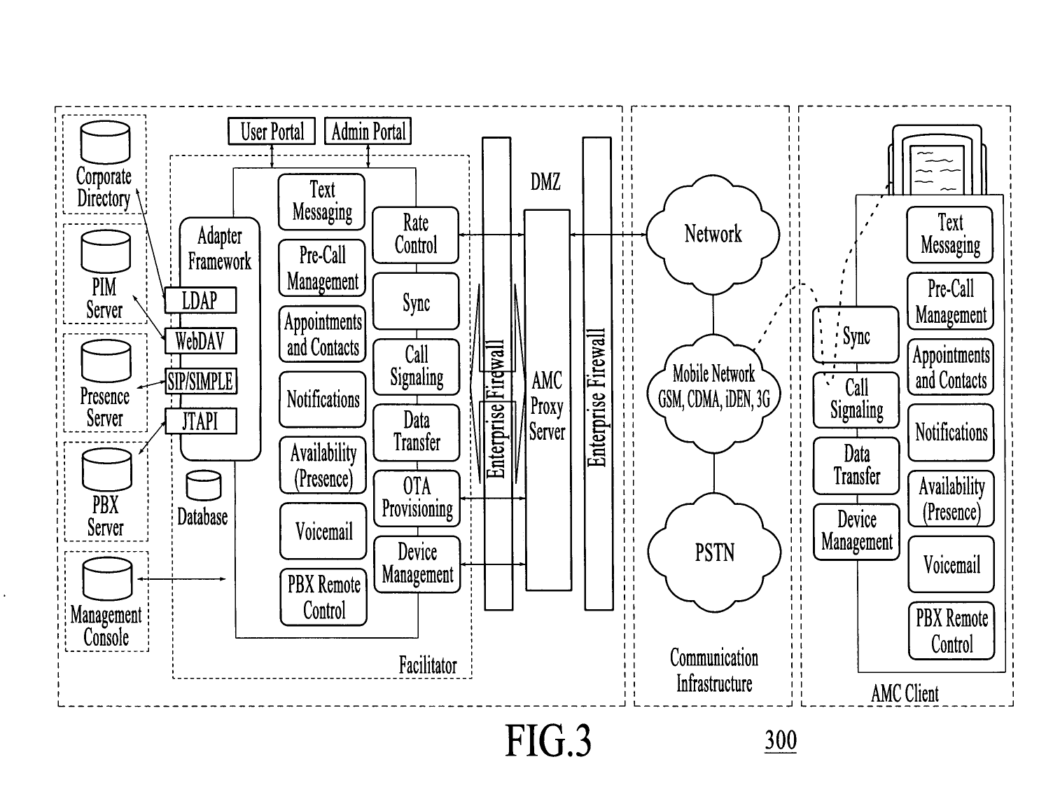

FIG. 3 is a block diagram of a communications system 300 that includes an AMC system, under another alternative embodiment. The communications system 300 includes enterprise components, with which the AMC system is integrated, coupled to client devices via a communication or network infrastructure. The enterprise components include, but are not limited to, one or more of a corporate directory, Personal Information Manager (PIM) server, presence server, Private Branch Exchange (PBX) server, and management console.

The AMC system includes a facilitator as described herein. The facilitator includes an adapter or adapter framework by which the facilitator simultaneously integrates with components of the enterprise and enterprise servers. The facilitator uses an adapter for each directory server to which it integrates. The adapter of an embodiment is a protocol-specific adapter for each directory server to which it integrates; alternatively, the adapter includes vendor-specific adapters. The facilitator integrates with multiple directories simultaneously, including Lightweight Directory Access Protocol (LDAP)/Active Directory, Exchange, Domino, and third-party instant message (IM)/presence server buddy-lists. The AMC adapters convert the data from the enterprise directories (e.g. external) into a common data structure. The converted data is coalesced together into a single directory presented to the user on device via the client. The single directory generated from the data of multiple directories is referred to as the AMC phonebook.

The facilitator includes one or more applications that support multiple functions provided by the AMC system. The AMC system functions include, but are not limited to, test messaging, pre-call management, appointments and contacts, notifications, availability (presence), voicemail, and PBX remote control.

The facilitator couples to a device of one or more users via one or more network couplings or infrastructures. As an example, the facilitator couples to a mobile network using a coupling with another communications network (e.g. Internet). The mobile network or mobile infrastructure, which includes one or more service provider networks associated with respective ones of the devices, provides a coupling to individual devices.

Communications between the facilitator and the device are controlled by the facilitator using one or more components and applications. The functions provided by the facilitator in controlling communications include one or more of rate control, synchronization (sync), call signaling, data transfer, OTA provisioning, and device management to name a few. Optionally, the communications path between the facilitator and the communications network includes an AMC proxy server.

The AMC system of an embodiment facilitates the exchange of contextual data before a mobile call takes place giving would be callers (call originators) important cues as to the appropriateness of their conversation to the receiver's (call recipient's) current situation. Components of the AMC system monitor the availability state of each user or subscriber (where the user has a handset hosting the AMC client) and broadcast that state to interested parties or “watchers”. In addition the AMC system introduces an Active Call Request that allows a caller to politely ask a receiver if the receiver is ready to take a phone call, and provides discreet response options by which the receiver can provide timely feedback to the caller. Callers have the satisfaction of knowing the receiver acknowledged their call request and will make time to talk.

Contextual availability management empowers users with greater granularity and control over their ability and willingness to communicate from their handset throughout the workday. Users control their availability state from their handsets through selection of an availability profile, where users tailor the availability profiles to suit their personal needs and tastes. Users are encouraged to change their profile whenever their ability to receive and process communications changes, such as entering and leaving a meeting. Availability profiles are controlled manually via direct user action, for example, as well as automatically via predetermined rules selected by the user and/or information of the user's calendar.

When a user initiates a call request, the facilitator of the AMC system for example monitors the communication. When the message is delivered successfully, the facilitator sends the caller a delivery confirmation. If the receiver is not reachable (e.g., off the mobile network) the facilitator queues the request and delivers it as soon as possible. If the message can't be delivered before it expires, the facilitator notifies the caller that the request was undeliverable and explains why. In this way callers are never left wondering whether or not their message was delivered.

The AMC system also lets called users pre-screen phone calls and call requests through filters based on the originator's phone number and the urgency of the request. When AMC call requests do come through, the AMC system provides additional contextual data, such as call urgency and subject material that subscribers can use to manage their time more efficiently. Thus, information of context determines the best communications modes to connect people wherever, whenever desired (e.g., voice, voice to text, text only).

Availability profiles of an embodiment also include call screening or filter attributes that a user may turn on or off depending on their personal needs. The AMC system of an embodiment supports Priority, Allow List, and Block List filters, but is not so limited. Activation of these filters is achieved by selecting an availability profile. Various combinations of the filters are allowed, and each profile may have a different combination of filters. Users create profiles from the portal depending on their personal needs and desires.

The priority filter defines the minimum level of AMC message priority for which the user is willing to receive notification. The user receives all AMC messages, but is only notified (e.g., audible alerts) upon receipt of a message designated at or above the allowed priority level. The characteristics of the notification are defined by the currently active availability profile. The Priority filter can act alone or be combined with the Block and Allow Lists to filter the AMC message traffic permitted by the Block and Allow Lists.

The Priority filter allows user selection of one priority value from among “Normal”, “Important”, and “Critical” priorities. Selection of the Priority filter indicates the minimum level for which the user wants to receive AMC message notifications (e.g., audible alerts). For example, if the user selects “Important”, he/she is notified when AMC messages with the priority set to “Important” and “Critical” are received.

The Allow List filter defines a list of phone numbers and/or AMC subscriber names for which the user wishes to receive notification. The user receives all AMC messages and mobile calls as normal, but is only notified (e.g., audible alert) when a message or mobile call is received from a member of the Allow List. The characteristics of the notification are defined by the currently active availability profile. Messages from people who are not members of the Allow List are still delivered to the handset but not accompanied by a notification. Phone calls by non-members of the Allow List are transferred to voicemail if possible.

The Allow (Only) List contents include phone numbers and names for allowed parties as well as caller groups. The Allow List filter also supports allowing calls based on international phone numbers. Duplication of entries between the Allow List and Block List is not permitted. Phone numbers can be added to and deleted from this filter from the host handset. Changes to the Allow List at the handset are updated at the facilitator the first time the handset and facilitator connect after the change. The subscriber can add, delete, and otherwise modify the contents of the Allow List at the portal, and changes to the Allow List at the portal are transferred to the subscriber's handset the first time the handset and facilitator connect following the change. Notifications of AMC call requests from members of the Allow List are provided to the handset; all other call requests are delivered to the handset without notification. Incoming phone calls from members of the Allow List are handled by the AMC client so that the handset rings subject to the active availability profile, but the embodiment is not so limited.

The Block List filter defines a list of phone numbers and/or names from which the user wishes not to receive messages or mobile phone calls. Blocked AMC messages are never delivered to the subscriber's handset, but are not so limited. An incoming mobile call from a number or name on the Block List is screened completely so that the called phone does not ring and the caller is optionally not transferred to voicemail; the call is ignored completely.

The Block List filter contents include phone numbers and names for parties to be blocked. The Block List filter also supports blocking based on international phone numbers. Phone numbers can be added to and deleted from this filter from the host handset. Changes to the Block List at the handset are updated at the facilitator the first time the handset and facilitator connect after the change. The subscriber can add, delete, and otherwise modify the contents of the Block List at the portal, and changes to the Block List at the portal are transferred to the subscriber's handset the first time the handset and facilitator connect following the change. AMC call requests from members of the Block List are blocked by the facilitator, where the facilitator provides a pre-specified message to the requesting device. Incoming phone calls from members of the Block List are blocked by the AMC client so that the handset will not ring and optionally the caller is not transferred to voicemail, but the embodiment is not so limited.

The AMC system of an embodiment supports active calling and messaging between subscribers and non-subscribers of services of the AMC system. While all features of the AMC system described above may not be available for calling/messaging when one of the parties is a non-subscriber or has a handset that does not include an AMC client, subsets of the features are supported as described below.

The AMC system of an embodiment automatically determines a correct addressing or formatting scheme for a message recipient based on attributes of the recipient. The attributes include whether the selected message recipient is a subscriber or non-subscriber of services of the AMC system. While contact information of the selected recipient is in a directory to which the caller has access, the subscriber status information of the recipient may not be available. When the recipient is a subscriber of the AMC system, the generated message is transferred to the recipient via components of the AMC system. When the recipient is not a subscriber of the AMC system, components of the AMC system determines a format for transferring the message to the recipient. Example formats for messaging a non-subscriber include an electronic mail message format, an instant message format, a Short Message Service (SMS) format, a Multimedia Messaging Service (MMS) format, an Enhanced Messaging Service (EMS) format, and a voice mail format to name a few. Thus, the AMC system determines the appropriate method to use in delivering messages to anyone in a contact list regardless of attributes or membership in AMC system. This allows a user to select a recipient from a contact list without know whether the recipient is inside or outside of the AMC system. The AMC system automatically determines how to construct and deliver the message so that, without any required user input, a secure AMC system message is transferred when the recipient is inside the AMC system,.and another delivery mechanism is used as appropriate when the recipient is outside the AMC system.

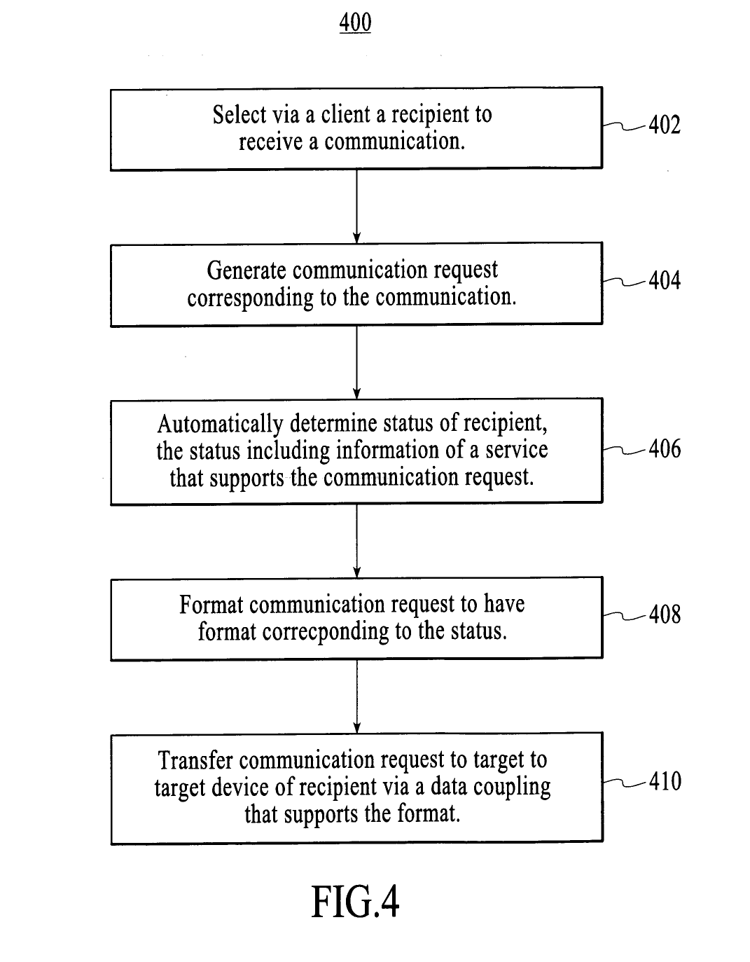

FIG. 4 is a flow diagram for determining message format according to status information 400, under an embodiment. The formatting 400 includes selecting 402 via the client a recipient to receive a communication. A communication request is generated 404 corresponding to the communication. A status of the recipient is automatically determined 406. The status includes information of a service that supports the communication request. The communication request is formatted 408 to have a format that corresponds to the status, and the formatted communication request is transferred 410 to a target device of the recipient via a data coupling that supports the format.

As an example, the AMC system of an embodiment supports the provision of message services to a recipient/subscriber (having a handset that includes an AMC client) from an originator/non-subscriber (handset does not include AMC client or user does not subscribe to AMC services) (also referred to herein as “N2O communication” or “N2O”). The Allow List and Block List filtering described above is supported on the recipient's (subscriber) handset for use in filtering calls from non-subscriber originators. Further, if the incoming call is missed by the recipient (subscriber), the client device of the recipient (subscriber) generates an alert message, where the alert message is referred to herein as a Notification of Missed Call from Non-Subscriber alert message (NO-1a).

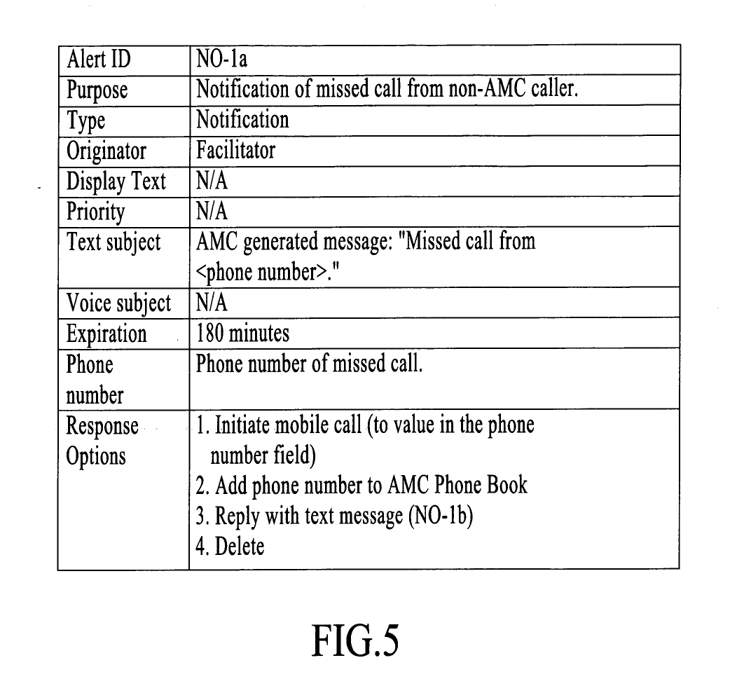

FIG. 5 is a template of the Notification of Missed Call from Non-Subscriber alert message (NO-1a), under an embodiment. This alert message supports a number of response options by the recipient (subscriber) including initiating a mobile call to the originator (non-subscriber) using the value in the phone number field of the alert message, adding the originator's (non-subscriber) phone number to the AMC phonebook, responding with a text message, and deleting the request. Actions by the recipient (subscriber) including initiating the mobile phone call result in automatic deletion of the alert message from the recipient's device, but the embodiment is not so limited.

When the recipient (subscriber) selects the response option to respond to the missed call with a text message, the recipient (subscriber) is provided with a message template on his/her handset. The message template includes a subject area, a message area, and an area for the recipient's phone number. The message template supports user keying of text subjects and the recipient's phone number. Further, the AMC client generates and supports selection of pre-defined text subjects by the user.

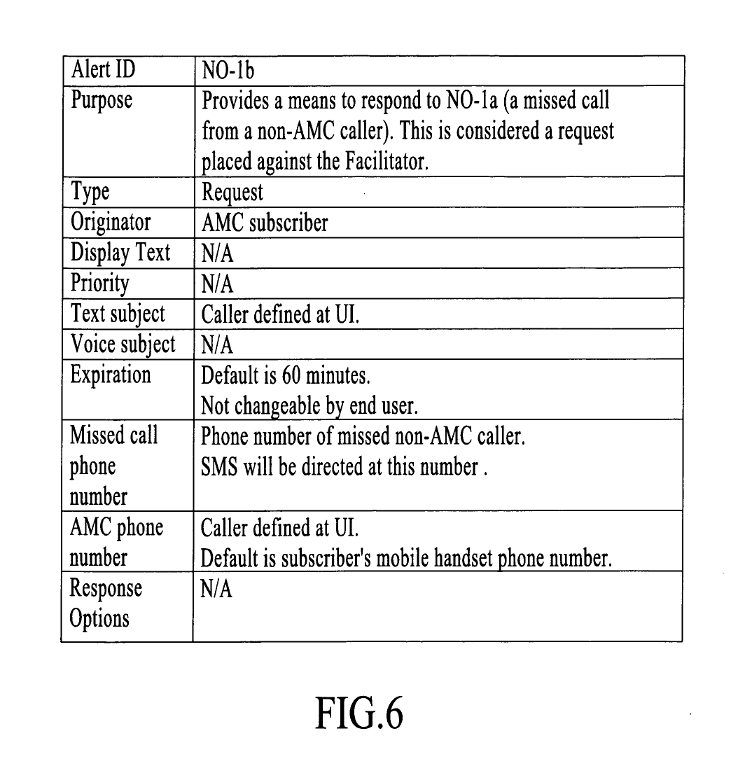

Once generated, the response text message is transferred from the recipient's (subscriber) handset to the call originator by repackaging the contents of the response message into an push message directed at the mobile phone number of the call originator (non-subscriber). Examples of push messages include SMS, MMS, but are not so limited. Delivery confirmation states of the push message are provided to the recipient (subscriber), and these states include at least one of “Not Sent”, “In Transit”, “Delivered”, and “Delivery Failed”. FIG. 6 is a template of the Response to Missed Call from Non-Subscriber alert message (NO-1b), under an embodiment.

All messages initiated by subscribers begin in the “Not Sent” state. This state ends when the message is successfully pushed out, the message expires, or the message is retracted or deleted.

The “In Transit” state begins when a message is successfully pushed out. This state ends when one of the following conditions occur: the recipient handset successfully receives message and acknowledges receipt; the message expires; and the message is retracted or deleted.

The “Delivered” state begins when a message is successfully delivered to the intended recipient's handset. This state ends when one of the following conditions occur: the message is deleted by the recipient; the subscriber does not respond before a message expires; the message is retracted; and the message is forwarded to another subscriber.

The “Failed to Deliver” state begins when delivery of a message to an intended recipient fails. In the “Failed to Deliver” state the AMC system continues to try and deliver a message to the intended recipient(s) until the message expiration is reached. When this happens, the AMC system sends a notification message to the originator with a description of the failure (to the extent possible). If a user-defined expiration is not specified, the AMC system uses a default expiration value.

In addition to providing message services to a recipient/subscriber from an originator/non-subscriber described above, the AMC system also supports an originator/subscriber calling/messaging a recipient/non-subscriber (also referred to herein as “O2N communication” or “O2N”). The AMC system upon initiation of an Active Call Request by an originator (subscriber) to a recipient (non-subscriber) provides the originator various options to tailor the request to his/her unique situation and to provide more context to the recipient (non-subscriber). Active Call Requests to non-subscribers support numerous input options including priority, text subject, originator's phone number, and expiration time to name a few.

The priority input option allows the originator (subscriber) to select one of Normal, Important, and Critical priorities. The Normal priority is the lowest level and the Critical priority is the highest level, but the embodiment is not so limited.

The text subject input option allows the originator (subscriber) to key a text subject tag. An embodiment supports selection of pre-defined text subjects, and the portal supports definition of the pre-defined text subjects.

The originator's (subscriber) phone number input option supports originator (subscriber) keying of phone numbers and embedding of these phone numbers in the request alert. The default number is the originator's (subscriber) mobile phone number. The expiration time input option allows the originator (subscriber) to input an expiration time value at the handset to specify a time period after which the Active Call Request automatically expires.

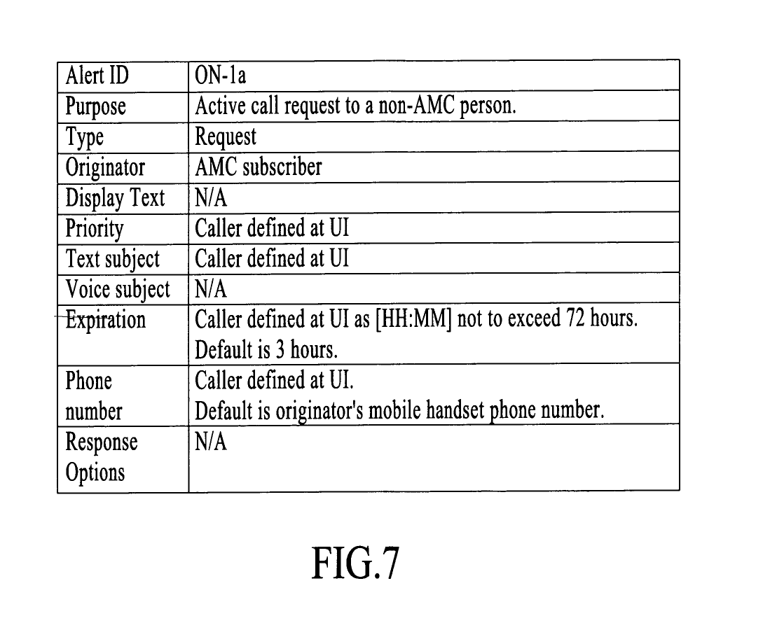

Once generated, the active call request to the recipient (non-subscriber) is transferred to the originator's (subscriber) handset by the AMC system. The AMC system repackages contents of the Active Call Request into an SMS message directed at the mobile phone number of the recipient (non-subscriber). As one example, the SMS message is as follows: “<Originator name> at <phone number> is requesting to speak with you before <local expiration time>. <Priority>”. Delivery confirmation states of the call request SMS message are provided to the originator (subscriber), and these states include at least one of “Not Sent”, “In Transit”, “Delivered”, and “Delivery Failed”. FIG. 7 is a template of the Active Call Request to a Non-Subscriber (ON-1a), under an embodiment.

The O2N and N2O are in many ways coupled, as a response to an O2N communication is an N2O communication. The description that follows includes many facets of such communications, which may be part of a N2O or O2N dialog. Several items relating to N2O/O2N could be applied to O2O as well.

For an O2N active call, the client notifies the server of the active call request. The client also sends an push message, typically a SMS, to the non-subscriber user. Further, the client generates a new entry in the conversation log of the matched user (matching is described below). A new conversation is created if none exists.

An incoming push message (e.g., a SMS message) (from a subscriber or non-subscriber user) creates a new conversation if none exists, or is appended to an open conversation if one exists. This covers the cases for a non-subscriber user initiating a conversation with a subscriber user, and a non-subscriber user responding to an active call initiated by a subscriber user. This functionality can also be supported for a subscriber user who initiated a conversation using SMS. The client notifies the server of this communication during synchronization. An incoming SMS received by a subscriber user should update display indicators to reflect that it is the subscriber user's “turn” in the conversation.

An SMS sent as a reply to a N2O call is sent immediately without requiring communication with the server, but is not so limited. The SMS is also added to the relevant conversation log. The server is notified of such communication during synchronization. An SMS reply sent by a subscriber user should update display indicators to reflect that it is the non-subscriber user's “turn” in the conversation.

Server-defined response strings can be sent in an N2O-reply SMS, or the user can enter message text through an editor.

An incoming, missed call from a subscriber or non- subscriber user is added to the relevant conversation log, or creates a new conversation if none exists. The server is notified of such communication attempt upon synchronization.

An incoming completing call is added to any existing conversation. If there is no existing conversation, none is created.

The SMS messages sent and/or received by the subscriber phone appear on the native inbox/outbox of the phone, and are not be deleted by the subscriber application. Received SMS messages have no effect on the subscriber application.

Matching of phone numbers and subscriber users compares the caller ID string with the tail of all phone numbers in the contacts database (mobile and otherwise) used by the subscriber client.

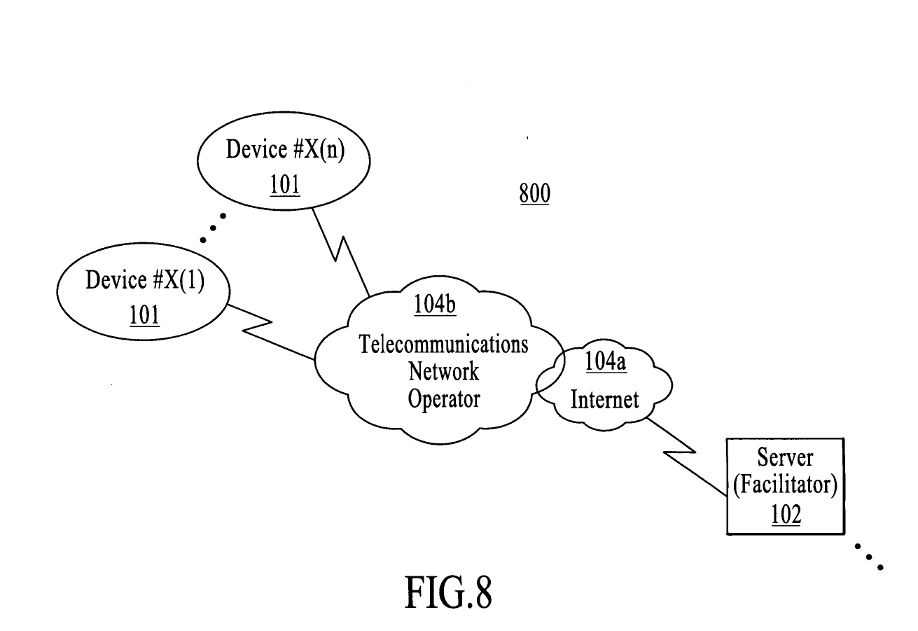

Some examples follow of alternative AMC system configurations that include the facilitator and client described above. FIG. 8 is a block diagram of an AMC system 800, under an alternative embodiment. The AMC system 800 includes a server or other processor-based device hosting the facilitator 102. The facilitator 102 communicates with one or more client devices 101 to provide AMC system functions among the client devices 101 via network couplings that include the Internet 104a and a telecommunications network 104b. The telecommunications network 104b includes, for example, a cellular telephone network or a public switched telephone network (PTSN), but can be other voice and data communication networks as known in the art. The cellular telephone network can use communication protocols that include, for example, Global System for Mobile communication (GSM), General Packet Radio Service (GPRS), Code Division Multiple Access (CDMA), and Time Division Multiple Access (TDMA), but are not so limited.

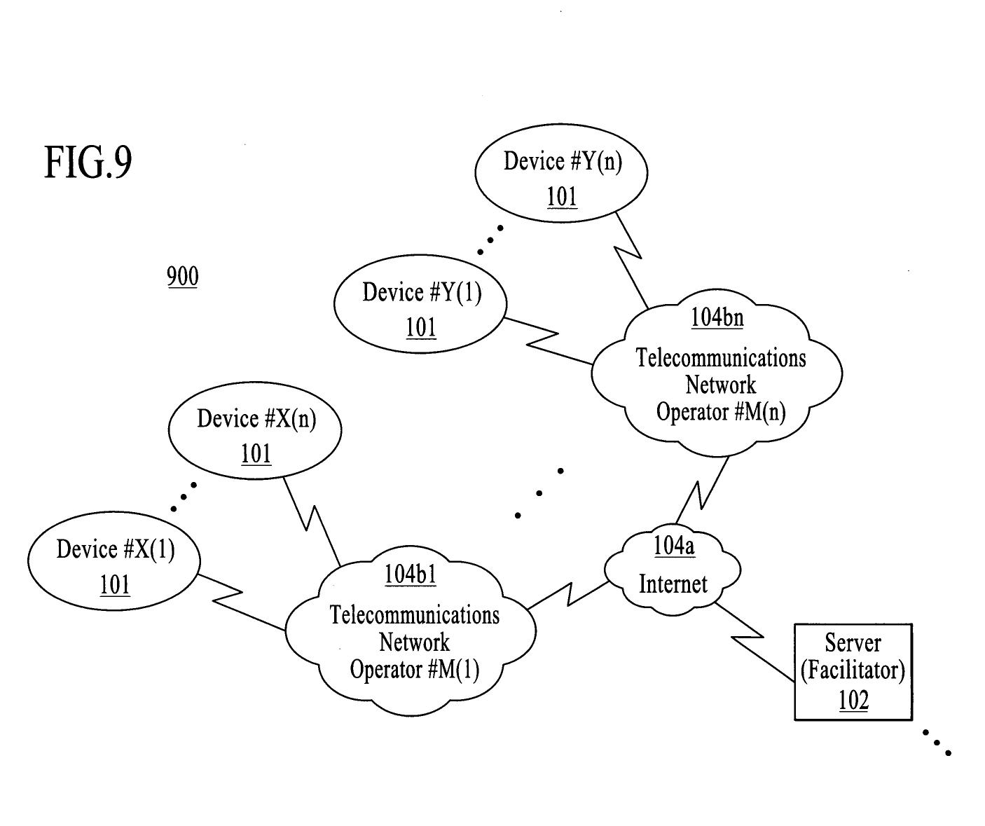

FIG. 9 is a block diagram of an AMC system 900, under another alternative embodiment. The AMC system 900 includes a server hosting the facilitator 102, and the facilitator 102 communicates with one or more client devices 101 to provide AMC system functions among the client devices 101 via network couplings that include the Internet 104a and/or multiple telecommunications networks 104b1 to 104bn. The telecommunications networks 104b1-104bn are as described above with reference to FIG. 8, but are not so limited.

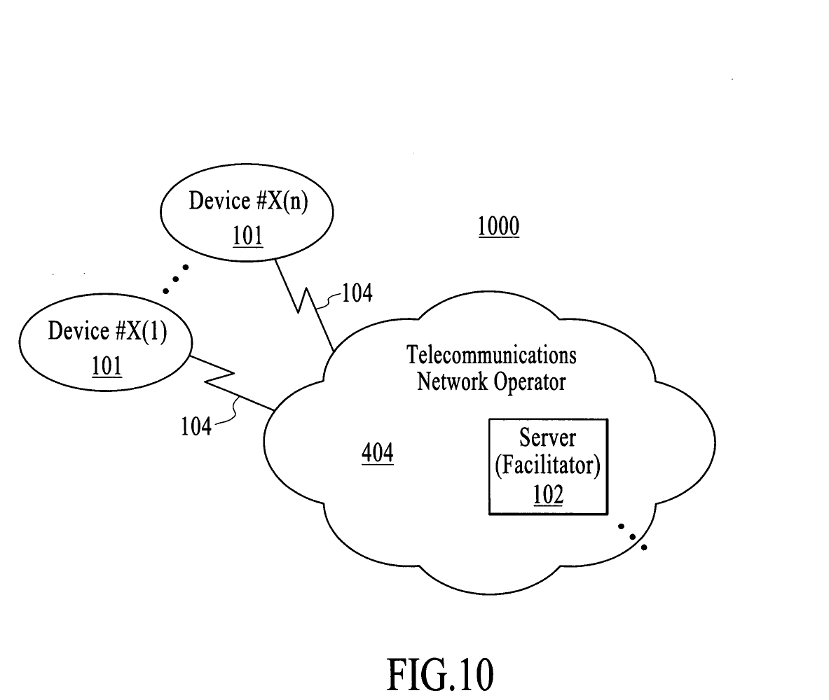

FIG. 10 is a block diagram of an AMC system 1000, under yet another alternative embodiment. The AMC system 1000 includes a server hosting the facilitator 102, and the server/facilitator 102 is a component of a telecommunications network operator infrastructure. The facilitator 102 communicates with one or more client devices 101 to provide AMC system functions among the client devices 101 via network couplings 104, as described above, but is not so limited.

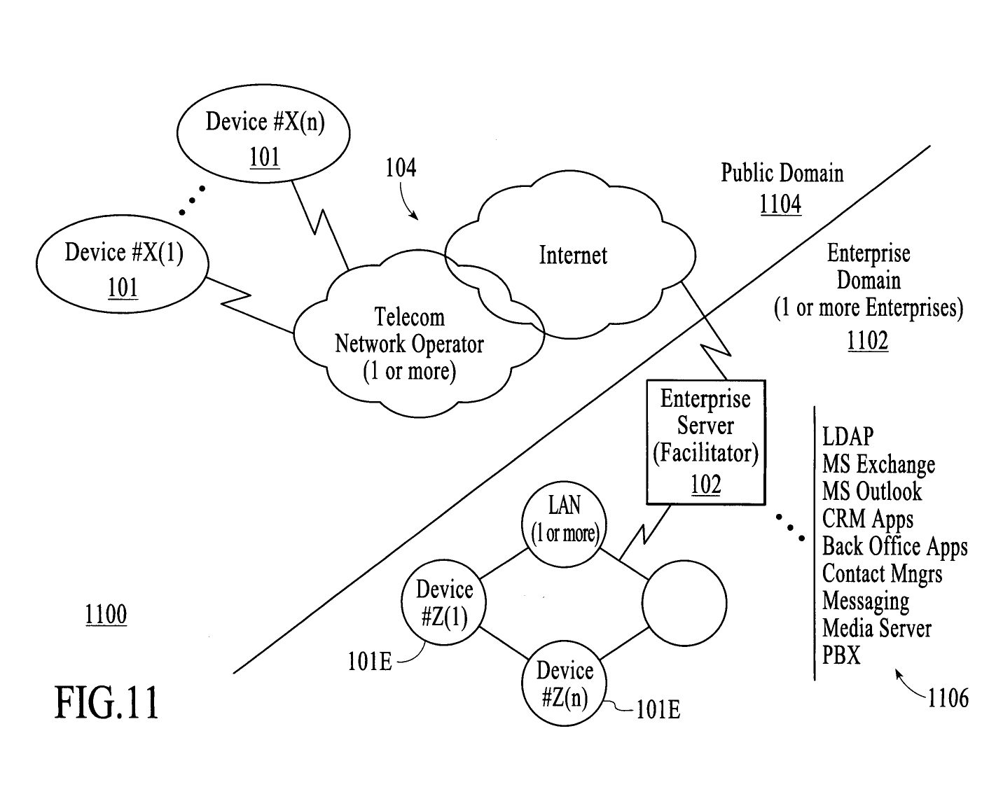

FIG. 11 is a block diagram of an AMC system 1100 in an enterprise domain, under another alternative embodiment. The AMC system 1100 includes a server hosting the facilitator 102 where the server/facilitator 102 is a component of a corporate or enterprise infrastructure 1102. The server can host numerous additional applications 1106 in addition to the facilitator 102 or can be dedicated to the facilitator 102. The facilitator 102 communicates with one or more client devices 101 in the public domain 1104 to provide AMC system functions among the client devices 101 via network couplings 104. The network couplings 104 include, for example, the Internet and one or more telecommunication service provider infrastructures, but can include any number/type of couplings. The facilitator 102 also communicates with one or more client devices 101 E in the enterprise domain 1102 to provide AMC system functions among the client devices 101E as described below. The client devices 101E in the enterprise domain 1102 are shown coupled to one or more LANs, but are not so limited.

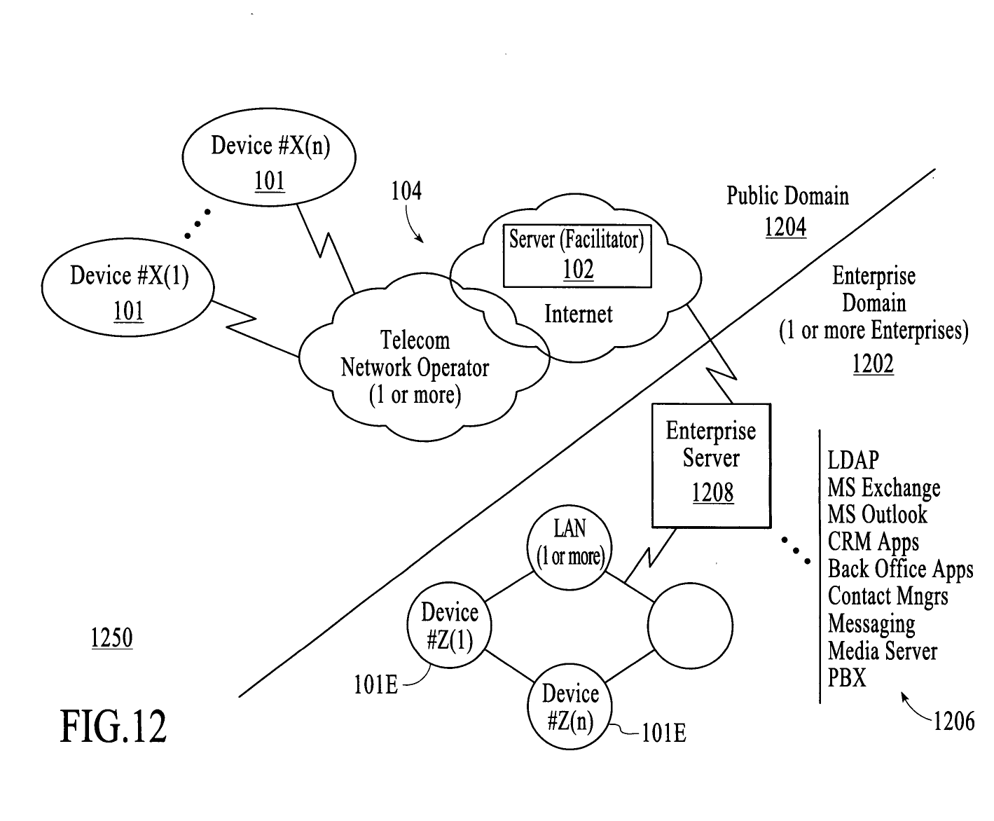

FIG. 12 is a block diagram of an AMC system 1250 in a public domain coupled across components of an enterprise domain, under another alternative embodiment. The AMC system 1250 includes a server hosting the facilitator 102 where the server/facilitator 102 is a component of a carrier or service provider infrastructure or hosted data center infrastructure for example, but is not so limited. The facilitator 102 communicates with one or more client devices 101 in the public domain 1204 to provide AMC system functions among the client devices 101 via network couplings 104. The network couplings 104 include, for example, the Internet and one or more telecommunication service provider infrastructures, but can include any number/type of couplings. The facilitator 102 also communicates with components of the enterprise domain 1202 including, for example, one or more client devices 101E, one or more enterprise servers 1208, and one or more LANs. The facilitator 102 provides AMC system functions among the client devices 101E as described below. The client devices 101E in the enterprise domain 1202 are shown coupled to one or more LANs, but are not so limited.

As an alternative to the couplings of this AMC system, the facilitator can be hosted on one or more servers (not shown) of the telecommunications network operator. The facilitator of the telecommunications network operator couples to the enterprise servers via local contact servers (not shown) and/or Virtual Private Network (VPN) couplings, but is not so limited.

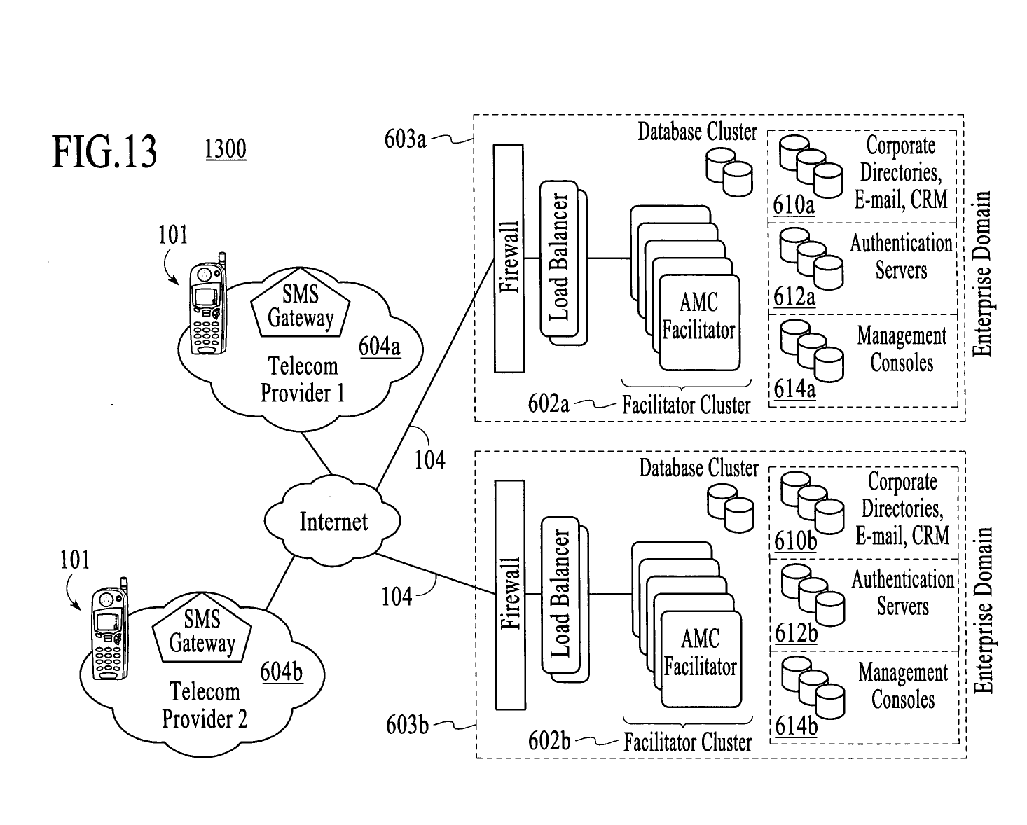

FIG. 13 is a block diagram of an AMC system 1300 in an enterprise domain, under still another alternative embodiment. The AMC system 1300 includes one or more facilitators that form facilitator clusters 602aand 602b within each of a number of enterprise domains 603a and 603b. Facilitators of the facilitator clusters 602a and 602b communicate with one or more client devices 101 to provide AMC system functions among the client devices 101 via network couplings 104. The network couplings 104 include, for example, at least one of the Internet and multiple telecommunication service providers 604a and 604b, but can include any number/type of couplings. The facilitators also couple with at least one of corporate directory servers and/or electronic mail (email) servers 610a/610b, authentication servers 612a/612b, and management consoles 614a/614b of the enterprise domains 603a/603b, but are not so limited.

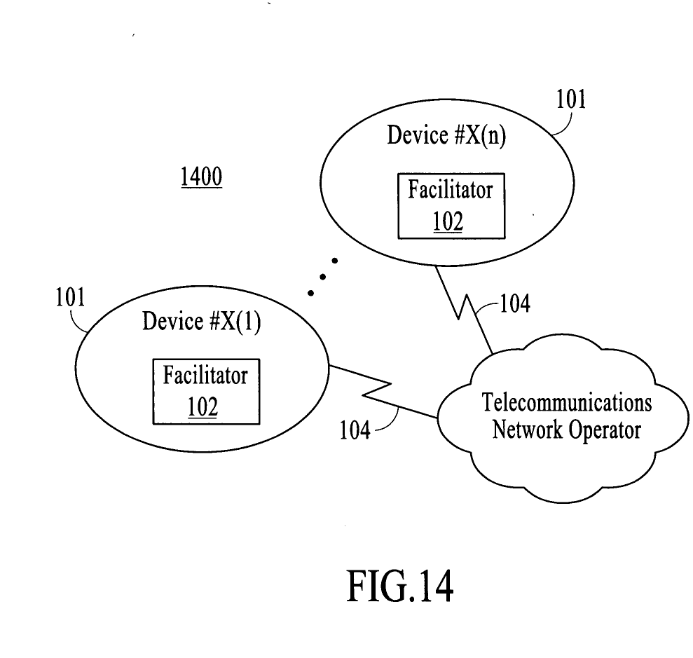

FIG. 14 is a block diagram of an active mobile collaboration (AMC) system 1400, under an embodiment. The AMC system 1400 includes any number X(n) of communication devices 101 coupled for communication via one or more facilitators 102 and one or more couplings 104. One or more of the communication devices 101 include an AMC client application. Additionally, one or more of the communication devices 101 include the facilitator 102. The AMC client applications and facilitator applications function to allow users of the communication devices to dynamically manage how and when mobile calls take place, intelligently screen calls based on caller identity, urgency, and subject matter, determine which contacts in a directory are available to talk and which ones choose not to be disturbed, and increase accessibility of enterprise and personal contact information from mobile phones, as described in detail below.

The AMC system components including the facilitator and AMC client described above function to allow users of the client devices or handsets like cellular telephones to quickly coordinate conversations, screen unwanted calls and interruptions and access enterprise directories. Specifically, the AMC system components increase call success rates by dynamically managing how and when mobile calls take place, let users intelligently screen calls based on caller identity, urgency and subject matter, quickly show which contacts are available to talk and which contacts choose not to be disturbed, reduce interruptions while encouraging urgently needed call-backs, and increase accessibility of enterprise and personal contact information from mobile phones.

Aspects of the communications systems described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the communications systems include: microcontrollers with memory (such as electronically erasable programmable read-only memory (EEPROM)), embedded microprocessors, firmware, software, etc. Furthermore, aspects of the communications systems may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the various systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the communications systems is not intended to be exhaustive or to limit the systems and methods described to the precise form disclosed. While specific embodiments of, and examples for, the communications systems are described herein for illustrative purposes, various equivalent modifications are possible within the scope of other communications systems and methods, as those skilled in the relevant art will recognize. The teachings of the communications systems provided herein can be applied to other processing systems and methods, not only for the systems and methods described above.

The elements and acts of the various embodiments described above can be combined to provide further embodiments. These and other changes can be made to the communications systems in light of the above detailed description.

In general, in the following claims, the terms used should not be construed to limit the communications systems to the specific embodiments disclosed in the specification and the claims, but should be construed to include all systems that operate under the claims. Accordingly, the communications systems is not limited by the disclosure, but instead the scope of the communications systems is to be determined entirely by the claims.

While certain aspects of the communications systems are presented below in certain claim forms, the inventors contemplate the various aspects of the communications systems in any number of claim forms. Accordingly, the inventors reserve the right to add additional claims after filing the application to pursue such additional claim forms for other aspects of the communications systems.

What is claimed is:

1. A method, comprising:
selecting via a calling device a recipient to receive a communication;
generating a communication request corresponding to the communication;
automatically determining a status of the recipient, the status including information of a service that supports the communication request;
formatting the communication request to have a format that corresponds to the status; and
transferring the communication request to a target device of the recipient via a data coupling that supports the format.

2. The method of claim 1, comprising generating a request entry in a conversation log, the request entry corresponding to the communication request.

3. The method of claim 1, comprising:
generating a response to the communication request at the target device;
automatically determining the status of a caller, wherein the caller generated the communication request;
formatting the response to have a format that corresponds to the status; and
transferring the response to the calling device via a data coupling that supports the format of the response.

4. The method of claim 3, comprising generating a response entry in a conversation log, the response entry corresponding to the response.

5. The method of claim 1, wherein the data coupling is a first data coupling when the status is subscriber of the service.

6. The method of claim 1, wherein the data coupling is a second data coupling when the status is non-subscriber of the service.

7. The method of claim 1, wherein the status is subscriber of the service, wherein the status of a caller using the calling device is non-subscriber.

8. The method of claim 7, comprising generating a plurality of response options on the target device in response to receipt of the communication request, wherein the response options include one or more of initiating the communication using information of the communication request, adding caller information to a directory, and generating a response message.

9. The method of claim 7, comprising generating a return data message including a text message.

10. The method of claim 9, wherein generating a return data message includes using pre-defined response strings.

11. The method of claim 9, comprising generating an entry in a conversation log, the entry corresponding to the return data message.

12. The method of claim 11, comprising one or more of initiating the communication, generating a response to the communication request using via one or more of text message, and generating a return communication request to the caller.

13. The method of claim 7, comprising screening the communication request, wherein the screening includes filtering the communication request using one or more of identity of the caller originating the communication request, priority of the communication request, subject of the communication request, and requested time of the communication.

14. The method of claim 13, wherein the screening uses one or more of a priority filter, an allow filter, and a block filter.

15. The method of claim 14, wherein the priority filter is configured to filter according to a minimum level of priority for which the recipient is willing to receive one or more of the communication request and the communication.

16. The method of claim 14, wherein the allow filter is configured to filter according to at least one list of callers from whom the recipient will receive one or more of the communication request and the communication.

17. The method of claim 14, wherein the block filter is configured to filter according to at least one list of callers from whom the recipient will not receive one or more of the communication request and the communication.

18. The method of claim 1, wherein the status is non-subscriber of the service, wherein the status of a caller using the calling device is subscriber.

19. The method of claim 18, comprising generating a plurality of request options on the calling device in response to generating the communication request, wherein the request options include one or more of priority options, text subject options, caller phone number options, and expiration time options.

20. The method of claim 18, wherein the formatting includes formatting the response to a text message format.

21. The method of claim 1, wherein a format of the communication request includes at least one of an electronic mail message format, an instant message format, a Short Message Service (SMS) format, a Multimedia Messaging Service (MMS) format, an Enhanced Messaging Service (EMS) format, and a voice mail format.

22. The method of claim 1, wherein the communication is a voice call and the communication request is a call request message.

23. The method of claim 1, comprising providing a delivery confirmation to the calling device in response to delivery of the communication request to the target device.

24. The method of claim 1, comprising generating a plurality of response options on the target device in response to receipt of the communication request, wherein the response options include at least one of accepting the communication request, postponing the communication request, generating a return data message including at least one of a text message and a voice message to the calling device, and initiating the communication.

25. The method of claim 18, comprising generating a response message in response to selection of a response option at the target device and transferring the response message to the calling device over the data coupling.
